(19) United States
(12) Patent Application Publication
(10) Pub. No.: US 2026/0136270 A1
(43) Pub. Date: May 14, 2026

(54) LOCATION BASED USAGE RESTRICTION FOR A NETWORK SLICE

(71) Applicant: Telefonaktiebolaget LM Ericsson (publ), Stockholm (SE)

(72) Inventors: George FOTI, Dollard Des Ormeaux, Québec (CA); Peter HEDMAN, Helsingborg (SE)

(73) Assignee: Telefonaktiebolaget LM Ericsson (publ), Stockholm (DE)

(21) Appl. No.: 19/101,959

(22) PCT Filed: Jul. 24, 2023
(86) PCT No.: PCT/EP2023/070423

§ 371 Date: Feb. 7, 2025

Related U.S. Application Data
(60) Provisional application No. 63/370,686, filed on Aug. 8, 2022.

(51) Int. Cl. H04W 48/04; H04W 48/18; H04W 60/04

(52) U.S. Cl. CPC H04W 48/04; H04W 48/18; H04W 60/04

(57) ABSTRACT

A method for performed by a user equipment. The method includes receiving (s1102) a message comprising network slice information, NSI, indicating a network slice and first location restriction information for the indicated network slice. The first location restriction information comprises a list of cell identifiers, IDs, and the list of cell IDs includes at least a first cell ID.

### TECHNICAL FIELD

Disclosed are embodiments related to network slices and restricting the user of network slices based on end-user location.

### BACKGROUND

A network slice is a logical (a.k.a., virtual) network that typically is designed to handle a specific use case. For example, a network operator may create a network slice for customers to solve a specific need. For instance, a network operatory may create a network slice to provide network connectivity to robots within different manufacturing facilities. In such a scenario, the operator's network may be configured such that an end-user (e.g., robot) can access the network slice only when the end-user is located within an approved manufacturing facility.

### SUMMARY

Certain challenges presently exist. For instance, a challenge with a network slice with location restriction is that in certain cases the location restriction may not align with any Tracking Area (TA), even though the network slice is supported in all cells of the TA. Hence it is not possible to have a Routing Area (RA) for such a slice for an intended UE. In some other cases, the location restriction can span more than one TA, in which case it is not feasible to include more than the TA where there is complete alignment in the RA. Hence, it is desirable to support a network slice (or “slice” for short) having location restriction not fully aligned with a TA, while not impacting the selection of an optimized RA to improve network performance, and to enable the customer to use the slice in the entire permitted area.

Accordingly, in one aspect there is provided a method for network slice location restriction. The method includes transmitting to a UE a message comprising network slice information indicating a network slice (e.g., S-NSSAI, network slice group ID) and first location restriction information for the indicated network slice, wherein the first location restriction information for the network slice comprises a list of cell identifiers, IDs, wherein the list of cell IDs includes at least a first cell ID.

In another aspect there is provided a method performed by a UE or by a Radio Access Network (RAN) node. The method includes receiving a message comprising network slice information (NSI) indicating a network slice and first location restriction information for the indicated network slice, wherein the first location restriction information comprises a list of cell identifiers, IDs, wherein the list of cell IDs includes at least a first cell ID.

In another aspect there is provided a method performed by a Unified Data Manager (UDM). The method includes transmitting to an AMF a message comprising network slice information indicating a network slice and first location restriction information for the indicated network slice, wherein the first location restriction information for the network slice comprises: a list of cell identifiers, IDs, and/or geographic information (e.g., zip code).

In another aspect there is provide a method for network slice location restriction, where the method includes transmitting to a UE a first message comprising information indicating that a network slice group is subject to a cell based location restriction, wherein the network slice group includes a least a first network slice.

In another aspect there is provide a method for network slice location restriction, where the method includes a UE receiving from a core network function (e.g., AMF) a first message comprising information indicating that a network slice group is subject to a cell based location restriction.

In another aspect there is provide a method performed by a RAN node serving a cell. The method includes obtaining information indicating that the cell supports a network slice group that is subject to a cell based location restriction. The method also includes transmitting in the cell system information for the cell, wherein the system information comprises information indicating that the cell supports the network slice group.

In another aspect there is provide a method performed by a RAN node where the method includes transmitting to a management function of a core network (e.g., AMF) a message comprising information indicating that a particular network slice group is subject to a cell based location restriction.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they enable cell based location restriction so that, for at least some network slices, only some cells of a Tracking Area or Routing Area support a network slice, while others do not.

### BRIEF DESCRIPTION OF THE DRAWINGS

The accompanying drawings, which are incorporated herein and form part of the specification, illustrate various embodiments.

FIG. 1 shows an example of a communication system 100 in accordance with some embodiments.

FIG. 2 shows a UE in accordance with some embodiments.

FIG. 3 shows a network node in accordance with some embodiments.

FIG. 4 shows a host in accordance with some embodiments.

FIG. 5 is a block diagram illustrating a virtualization environment in which functions implemented by some embodiments may be virtualized.

FIG. 6 shows a communication diagram of a host communicating via a network node with a UE over a partially wireless connection in accordance with some embodiments.

FIG. 7 shows a core network node in accordance with some embodiments.

FIG. 8 is a message flow diagram in accordance with some embodiments.

FIG. 9 is a message flow diagram in accordance with some embodiments.

FIG. 10 is a flowchart illustrating a process in accordance with some embodiments.

FIG. 11 is a flowchart illustrating a process in accordance with some embodiments.

FIG. 12 is a flowchart illustrating a process in accordance with some embodiments.

FIG. 13 is a flowchart illustrating a process in accordance with some embodiments.

FIG. 14 is a flowchart illustrating a process in accordance with some embodiments.

FIG. 15 is a flowchart illustrating a process in accordance with some embodiments.

FIG. 16 is a flowchart illustrating a process in accordance with some embodiments.

FIG. 17 is a message flow diagram in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the Appendix.

This disclosure provides two embodiments for addressing the case when Network Slice Area of Service for services not mapping to existing TAs boundaries. That is, the disclosure provides two embodiments for implementing an extended location restriction functionality.

During initial registration the UE indicates whether the UE supports the extended location restriction functionality. The Access and Mobility Management Function (AMF) applies current logic and if the UE requests or subscribes to a S-NSSAIs (Singe Network Slice Selection Assistance Information) that are applicable for the extended location restriction and the UE does not support the extended functionality, the network decides whether to provide the applicable S-NSSAI in Allowed Network Slice Selection Assistance Information (NSSAI) and Configured NSSAI to the UE. The decision can be implemented as operator policy in AMF, or decided by another Network Function (NF) (e.g. User Data Manager (UDM), Network Slice Selection Function (NSSF), or Policy Control Function (PCF), in which case the UE support needs to be forwarded to the another NF.

### First Embodiment (a.k.a., Service Area Restriction Extension)

In a first embodiment, access and mobility related policy information is extended such that Service Area Restrictions can be set per S-NSSAI on a per cell level granularity. The UDM can set Service Area Restrictions per subscribed S-NSSAI and also indicate the geographical information (e.g. longitude/latitude, zip code, etc) or list of cells, Network Slice AS Groups (NSAGs) if known. As per current logic, the PCF can further adjust the Service Area Restrictions, and then AMF sends the Service Area Restrictions to the UE. The UE then applies the Service Area Restrictions possibly on a per network slice and cell granularity.

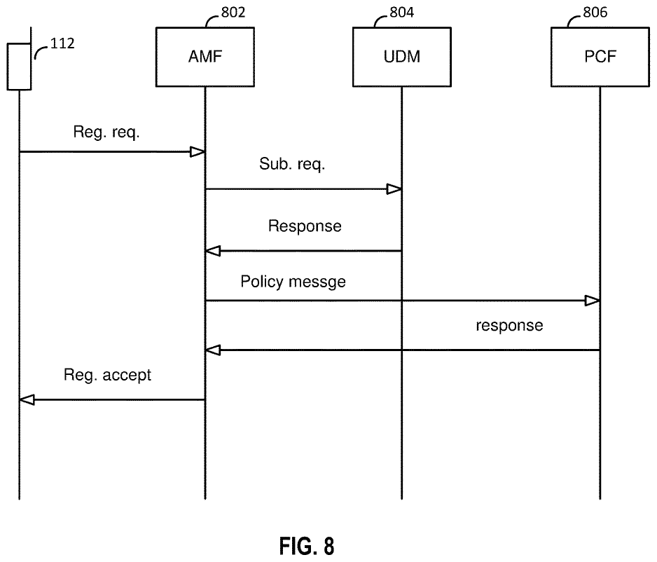

FIG. 8 is a message flow diagram illustrating the first embodiment.

As shown in FIG. 8, the UE 112 transmits to a core network node (which in this case implements an AMF 802) a registration message that indicates the UE's capability to support the extended location restriction functionality (e.g., in the UE 5GMM Core Network Capability).

After receiving the registration message, the AMF sends to another core network node (which in this case is a core network node that implements a UDM 804) a subscription request message requesting subscription information associated with UE 112. This request message may include an indication indicating that both the UE and serving network supports the extended location restriction functionality.

The UDM 804 responds to the request message by transmitting to the AMF a response message that provides Service Area Restrictions with per S-NSSAI restrictions. That is, for example, if a network slice available to the UE has a location restriction associated with it, the response message may include location restriction information for the network slice, wherein the location restriction information may include one or more of: a list of tracking area identities (TAIs), geographical information (e.g. longitude/latitude, zip code, place name, etc), a list of cells, or network slice group identifiers (e.g., NSAGs). The UDM can adapt the content of the response message based on the knowledge whether the UE and serving network supports the extended location restrictions.

After receiving the response message, in one embodiment, AMF transmits to a PCF 806 a policy association message (e.g., a policy association establishment to modification message) containing the location restriction information for each allowed network slice. The PCF may, for each allowed network slice, modify the location restriction information for the allowed network slice. For instance, the location restriction information for a particular network slice that is sent to the PCF may consist of a list of N cell identifiers; the PCF may add cell IDs to the list and/or remove cell IDs from the list, thereby creating updated location restriction information. The PCF then transmits to the AMF a response message comprising the updated location information.

After receiving the response message from the PCF, the AMF transmits to the UE registration accept message that includes network slice information (NSI) indicating at least one network slice (e.g., the NSI comprises a first S-NSSAI identifying a first network slice and a second S-NSSAI identifying a second network slice) and first location restriction information for the indicated network slice, wherein the first location restriction information comprises a list of cell identifiers, IDs, wherein the list of cell IDs includes at least a first cell ID. The list of cell IDs can be an allowed list that identifies the cells that support the indicated network slice or a not-allowed list that identifies cells that do not support the indicated slice.

The location first location restriction information that is sent to the UE by the AMF may be: i) the location restriction information received from the UDM, ii) the updated location restriction information received from the PCF, iii) location restriction information derived from the location restriction information received from the UDM and/or the PCF (e.g., if the location restriction information from the UDM/PCF comprises geographic information (e.g., zip code, place name, etc.), the AMF may map the geographic information to a set of cell IDs and include the set of cell IDs in the list provided to the UE); and iv) any combination thereof.

The UE stores the received location restriction information and enforces the indicated location restriction. That is, the UE applies the Allowed or Not-Allowed list per S-NSSAI (per network slice). For example, if the UE would like to use network slice #2, but the UE is in cell #3 and the message from AMF indicates that network slice #2 cannot be used in cell #3, then UE will refrain from using network slice #2 until the UE moves to an allowed cell. As another example, if the UE only has S-NSSAIs in Configured NSSAI with location restrictions and the UE does not find any cell that would allow any of the UE's S-NSSAIs the UE camps on a cell in any cell state (e.g., limited service state).

The Radio Access Network (RAN) can also be provided with the location restriction information per network slice to enforce the location restrictions. The AMF can also enforce the location restrictions. For example, if UE is in a cell that does not support a network slice (e.g., the cell is not on the allowed list of cells or is on the not-allowed list of cells), but the UE nevertheless attempts to register with the network slice by transmitting a registration request message, the AMF can reject the registration request.

In some embodiments, the UE can additionally report that the location restriction information has been stored.

### Second Embodiment (a.k.a., NSAG Option)

In a second embodiment, NSAGs are used to allow the cells of a RA/TA to support different NSAGs (i.e., allow non-homogeneous support of NSAGs within a RA/TA). That is, for example, some of the cells within an RA/TA my support the network slice in a particular NSAG, while other cells within the same RA/TA do not support any of the network slices in the particular NSAG. Each cell can indicate the NSAGs that it supports. For example, in one embodiment, a cell indicates that it supports an NSAG by including an identifier for the NSAG in system information (e.g., a System Information Block (SIB)) that the cell periodically broadcasts. The UE and RAN do not activate user plane (UP) data radio bearer (DRB) of network slices included in an NSAG that is not supported in current cell. The RAN can indicate to AMF during NG SETUP (CONFIGURATION UPDATE) that some NSAGs are supported in some cells of a TA (or list of TAs), besides the existing possibility to list used NSAGs per TA.

Alternatively, the AMF or NSSF can be configured that some NSAGs require UE capability to handle non-homogeneous support of NSAGs within TA (e.g. extended location restriction).

If an operator chooses to implement both embodiments, then both lists can be sent to the UE and the UE applies both lists simultaneously in order to determine if it can access a network slice in a specific cell.

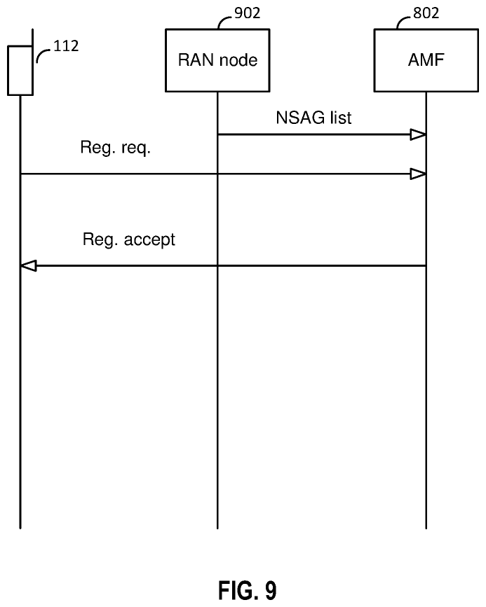

FIG. 9 is a message flow diagram illustrating the second embodiment.

As shown in FIG. 9, a RAN node 902 (e.g., gNB) can indicate to AMF during NG SETUP (CONFIGURATION UPDATE) a list of NSAGs that are supported by some of the cells in a TA but not all, besides the existing possibility to list supported NSAGs per TA. If RAN is not used to inform the AMF, then AMF can be configured by OAM.

As further shown in FIG. 9, the UE 112 transmits to the AMF 802 a registration message that indicates the UE's capability to support the extended location restriction functionality (e.g., in the UE 5GMM Core Network Capability).

After receiving the registration request message, the AMF transmits to the UE a registration accept message. If the UE supports the NSAG option, then, for each NSAG that includes a network slice allowed for the UE and that that is not supported in all cells of at least one TA, then the AMF will include in the message information indicating that the NSAG is subject to a cell based location restriction. For example, if the UE is allowed to use network slice #1 and network slice #2, slice #1 is a member of NSAG #1, slice #2 is a member of NSAG #2, NSAG #1 is supported in some cells of TA #1 but not all the cells of TA #1, and NSAG #2 is supported in some cells of TA #2 but not all the cells of TA #2, then the message sent by AMF to the UE will contain information indicating that NSAG #1 is subject to a cell based location restriction and NSAG #2 is subject to a cell based location restriction.

The UE stores the information and enforces the restrictions. For example, the UE does not activate UP if the NSAG is not supported by the current cell, and can adapt the cell re-selection. Thus, for instance, if the UE only has S-NSSAIs in Configured NSSAI with location restrictions and the UE does not find any cell that would allow any of the UE's S-NSSAIs the UE camps on a cell in any cell state (e.g., limited service state). In one embodiment, the UE is able to determine whether the cell it is currently connected to (or camped on) supports a particular NSAG because the cell will periodically broadcast system information indicating the NSAG(s) that it supports (e.g., a SIB transmitted by the cell may include an allowed list of NSAGs).

The Radio Access Network (RAN) can also be provided with this location restriction information per network slice to enforce the location restrictions. The AMF can also enforce the location restrictions. In some embodiments, the UE can additionally report that the location restriction information has been stored.

As noted above, an AMF can choose to support both options and send to the UE a list of NSAGs subject to cell based restriction as well as well as the extended Service Area Restrictions to the UE in a Registration Accept Message. The UE uses the information provided in both to determine its access to a slice in a specific cell. Another option is for the AMF to combine both lists and sends a single consolidated list to the UE.

### Mobility Procedures

For idle mode mobility, the NSAG option can be used to influence the cell re-selection such that the UE prefer cells supporting the NSAGs associated with the S-NSSAIs the UE wants including when not all cells of a TA support the same NSAGs (this should not have any protocol impacts as is assumed to be already supported by Radio Resource Control (RRC). The Service Area Restrictions extensions does not impact the idle mode mobility procedures.

For connected mode mobility, the NSAG option can enable the NG-RAN to steer the UE to cells supporting the NSAGs associated with the S-NSSAIs that the UE is using (by Allowed NSSAI and S-NSSAIs of activated PDU Sessions). For the Service Area Restriction Extension option, the RAN gets the extensions as part of the Mobility Restriction List (that is extended with per S-NSSAI and per cell restrictions) and the Mobility Restrictions for CM-CONNECTED state when in RRC-Connected state are executed by the radio access network and the core network such that UP for the associated S-NSSAIs are not allowed to be activated (as per current procedures).

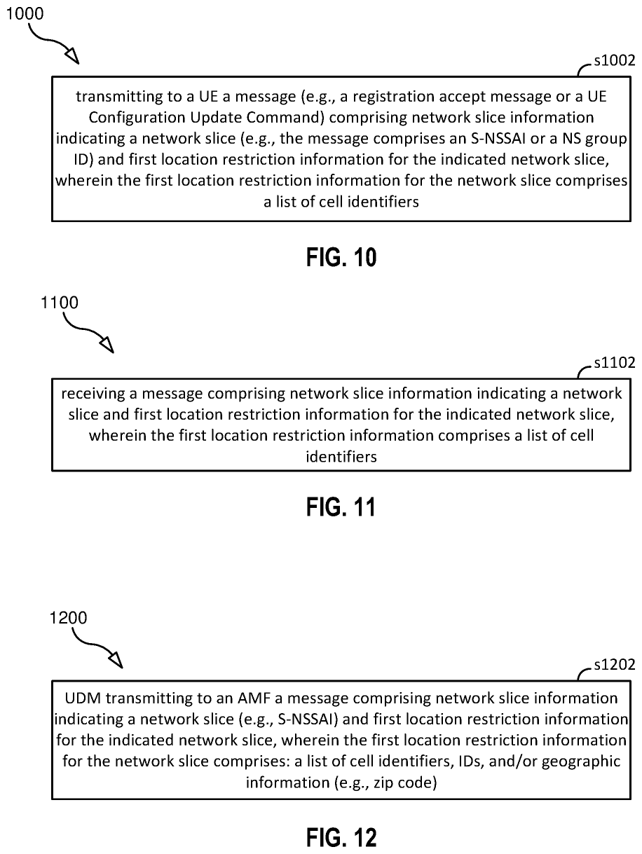

FIG. 10 is a flowchart illustrating a process 1000 according to an embodiment for network slice location restriction. The process includes step s1002. Step s1002 comprises transmitting to a UE a message (e.g., a registration accept message or a UE Configuration Update Command) comprising network slice information indicating a network slice (e.g., the message comprises an S-NSSAI) and first location restriction information for the indicated network slice, wherein the first location restriction information for the network slice comprises a list of cell identifiers, IDs, wherein the list of cell IDs includes at least a first cell ID (the first cell ID identifies a cell that supports the indicated network slice, or the first cell ID identifies a cell that does not support the indicated network slice).

In some embodiments, the process also includes prior to transmitting the message to the UE, receiving a registration request message transmitted by the UE, wherein the message transmitted to the UE is a registration accept message that is responsive to the registration request message.

In some embodiments, the process also includes, after receiving the registration request message, obtaining subscription information associated with the UE, wherein the subscription information comprises second location restriction information, and the second location restriction information comprises at least one of: one or more cell IDs that are included in the list of cell IDs, a geographical address, a postal code, a place name, a pair of coordinates (e.g., latitude and longitude).

In some embodiments, the process also includes generating the first location restriction information using the second location restriction information (e.g., converting a postal code or place name to a list of cell IDs). In some embodiments, the process also includes, prior to generating the first location restriction information and after receiving the registration request message, obtaining third location restriction information from a policy function, wherein the first location restriction information is generated using both the second location restriction information and the third location restriction information.

In some embodiments, the process is performed by an Access and Mobility Management Function, AMF. In some embodiments, the registration accept message comprises a Service Area Restriction IE and the Service Area Restriction comprises the first location restriction information.

In some embodiments, the list of cell IDs comprises a plurality of cell IDs, and each said identified cell either i) supports the indicated network slice or ii) does not support the indicated network slice. In some embodiment, each cell ID included in the list of cell IDs identifies a cell that is within the same tracking area.

In some embodiments, the process also includes determining whether to transmit to a radio access network, RAN, node a message comprising the network slice information indicating the network slice and the first location restriction information for the indicated network slice.

In some embodiments, the process also includes, prior to transmitting the message to the UE, obtaining capability information for the UE (e.g., the capability information may be included in the Registration Request message sent by the UE); and, based on the obtained capability information, determining to include in the message the first location restriction information for the indicated network slice.

FIG. 11 is a flowchart illustrating a process 1100 according to an embodiment for network slice location restriction. The process includes step s1102. Step s1102 comprises receiving a message comprising network slice information indicating a network slice (e.g., S-NSSAI) and first location restriction information for the indicated network slice, wherein the first location restriction information comprises a list of cell identifiers, IDs, wherein the list of cell IDs includes at least a first cell ID. In some embodiment, the process also includes storing and enforcing the first location restriction information. Process 1100 may be performed by UE 112 or RAN node 110.

FIG. 12 is a flowchart illustrating a process 1200 according to an embodiment for network slice location restriction. The process includes step s1202. Step s1202 comprises a UDM transmitting to an AMF a message comprising network slice information indicating a network slice (e.g., S-NSSAI) and first location restriction information for the indicated network slice, wherein the first location restriction information for the network slice comprises: a list of cell identifiers, IDs, and/or geographic information (e.g., zip code).

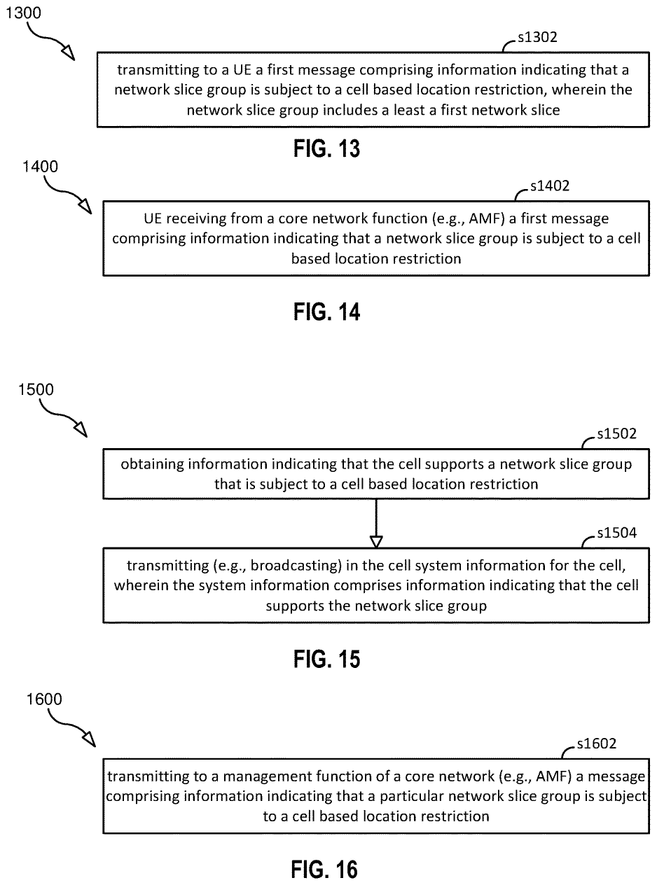

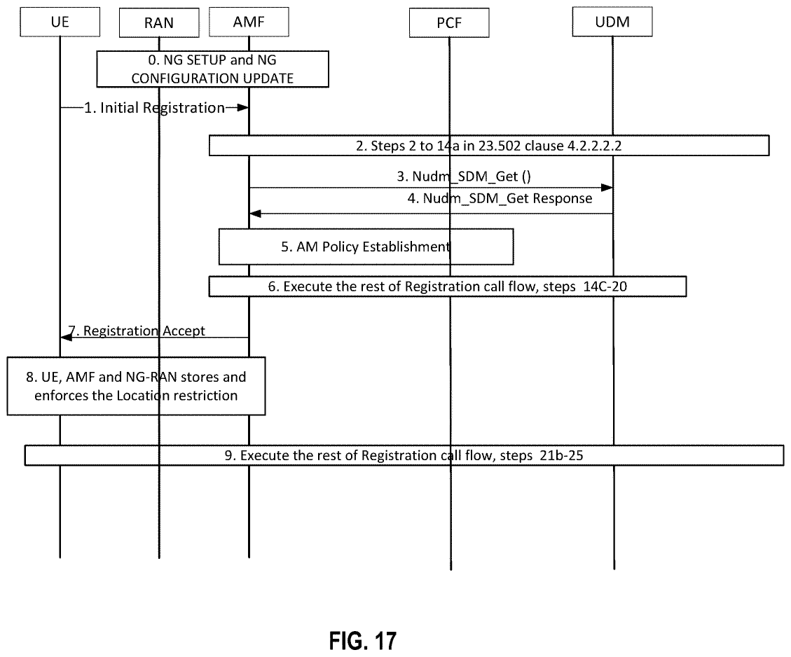

FIG. 13 is a flowchart illustrating a process 1300 according to an embodiment for network slice location restriction. The process includes step s1302. Step s1302 comprises transmitting to a UE a first message comprising information indicating that a network slice group is subject to a cell based location restriction, wherein the network slice group includes a least a first network slice. In some embodiments, the process also includes prior to transmitting the first message to the UE, receiving a registration request message transmitted by the UE, wherein the first message transmitted to the UE is a registration accept message that is responsive to the registration request message.

In some embodiments, the process also includes, prior to transmitting the first message to the UE, receiving a second message comprising information indicating that the network slice group is subject to a cell based location restriction.

In some embodiments, the information included in the first message comprises a network slice group identifier (e.g., a NSAG, network slice access stratum group, ID) that identifies the network slice group that is subject to the cell based location restriction.

In some embodiments, the process also includes prior to transmitting the message to the UE, obtaining capability information for the UE; and, based on the obtained capability information, determining to include in the first message the information indicating that the network slice group is subject to a cell based location restriction.

FIG. 14 is a flowchart illustrating a process 1400 according to an embodiment for network slice location restriction. The process includes step s1402. Step s1402 comprises a UE receiving from a core network function (e.g., AMF) a first message comprising information indicating that a network slice group is subject to a cell based location restriction.

In some embodiments, the process also includes the UE receiving system information broadcast by a base station serving a cell; and the UE determining whether the cell served by the base station supports the group of network slices, wherein the determining comprises: the UE determining whether the system information includes a group ID that identifies the network slice group.

In some embodiments, the first message comprises a group ID that identifies the network slice group, and determining whether the system information includes a group ID that identifies the network slice group comprises determining whether the system information includes a group ID that is identical to the group ID included in the first message.

In some embodiments, the process also includes, after determining that the cell served by the base station supports the group of network slices, the UE transmitting a registration request to register with one of the network slices in the group.

In some embodiments, the process also includes, after determining that the cell served by the base station supports the group of network slices, the UE transmitting a message comprising a network slice identifier identifying one of the network slices in the group. In some embodiments, the message further comprise a Protocol Data Unit (PDU) Session Establishment Request or a Service Request.

FIG. 15 is a flowchart illustrating a process 1500 according to an embodiment for network slice location restriction. The process includes step s1502. Step s1502 comprises obtaining information indicating that the cell supports a network slice group that is subject to a cell based location restriction. Step s1504 comprises transmitting (e.g., broadcasting) in the cell system information for the cell, wherein the system information comprises information indicating that the cell supports the network slice group. In some embodiments, the information indicating that the cell supports the network slice group comprise a network slice group identifier that identifies the network slice group.

FIG. 16 is a flowchart illustrating a process 1600 according to an embodiment for network slice location restriction. The process includes step s1602. Step s1602 comprises a RAN node transmitting to a management function of a core network (e.g., AMF) a message comprising information indicating that a particular network slice group is subject to a cell based location restriction. In some embodiments, the message is RAN Configuration Update message, or the message is an NG Setup Request Message. In some embodiments, the message further comprises location restriction information indicating a set of cells that support the particular network slice group. In some embodiments, the location restriction information comprises a list of cell identifiers for indicating the set of cells that support the particular network slice group and/or geographic information for indicating said set of cells.

If an operator implements both embodiments, then both lists can be sent to the UE and the UE applies both lists simultaneously in order to determine if it can access a network slice in a specific cell. Optionally the AMF can send an integrated list, or send to the UE the same information as in embodiment 1 supplemented with a new list including the extended information. The NSAG list sent to the UE remains the same as in embodiment 2 in all cases.

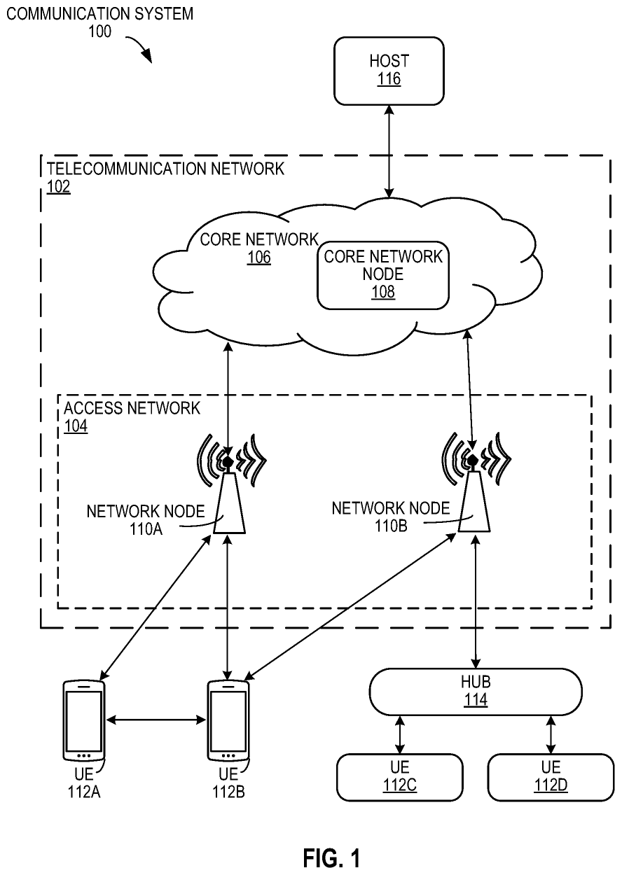

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (a.k.a., User Data Manager (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

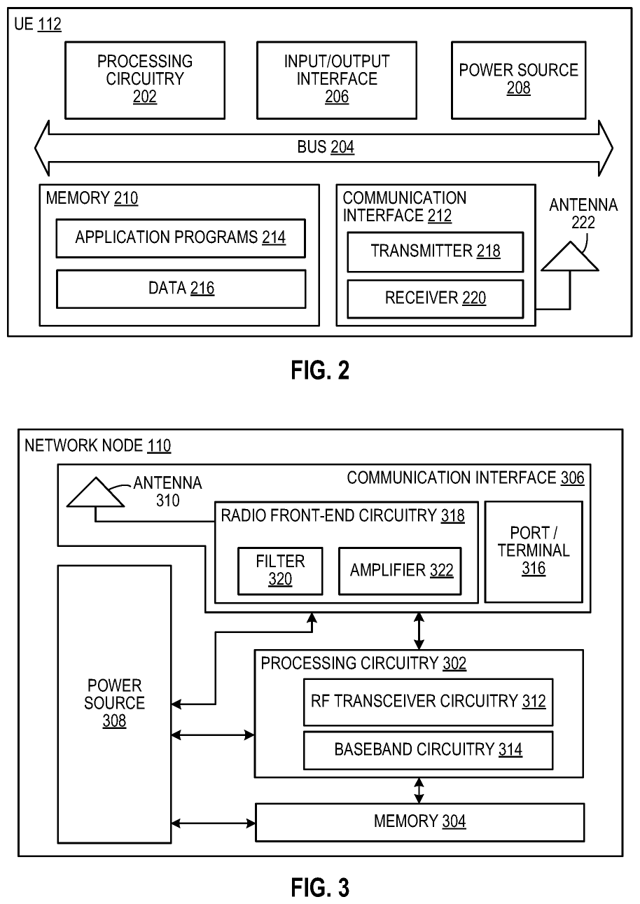

FIG. 2 shows a UE 112 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 112 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 112. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 112 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 112 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 112, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 112 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 112 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node 110 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 110 includes a processing circuitry 302, a memory 304, a communication interface 306, and a power source 308. The network node 110 may be composed of multiple physically separate components (e.g., a NodeB component and a RNC component, or a BTS component and a BSC component, etc.), which may each have their own respective components. In certain scenarios in which the network node 110 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 110 may be configured to support multiple radio access technologies (RATs). In such embodiments, some components may be duplicated (e.g., separate memory 304 for different RATs) and some components may be reused (e.g., a same antenna 310 may be shared by different RATs). The network node 110 may also include multiple sets of the various illustrated components for different wireless technologies integrated into network node 110, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 110.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 110 components, such as the memory 304, to provide network node 110 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 110. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302.

The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 110 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 110 and connectable to the network node 110 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 110 in a form suitable for the respective components (e.g., at a voltage and current level needed for each respective component). The power source 308 may further comprise, or be coupled to, power management circuitry to supply the components of the network node 110 with power for performing the functionality described herein. For example, the network node 110 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 110 may include additional components beyond those shown in FIG. 3 for providing certain aspects of the network node's functionality, including any of the functionality described herein and/or any functionality necessary to support the subject matter described herein. For example, the network node 110 may include user interface equipment to allow input of information into the network node 110 and to allow output of information from the network node 110. This may allow a user to perform diagnostic, maintenance, repair, and other administrative functions for the network node 110.

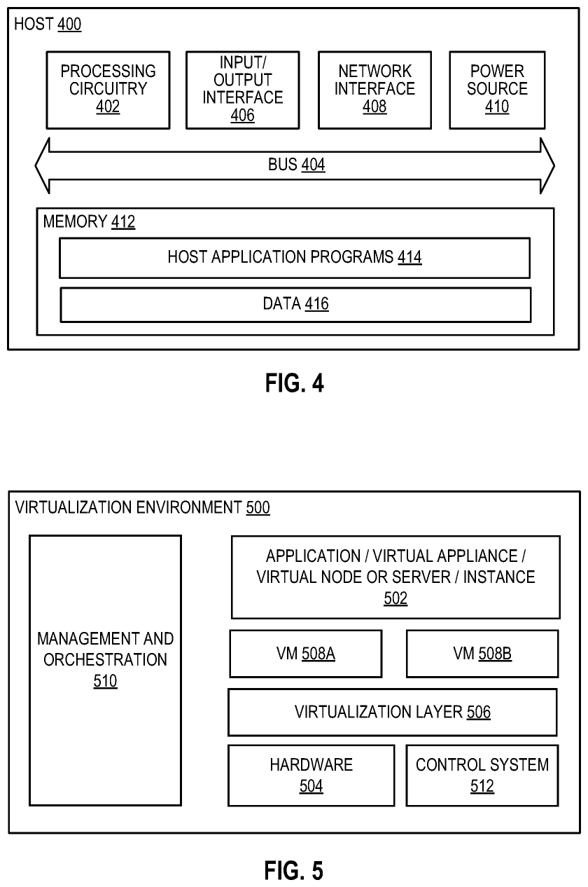

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 500 includes components defined by the O-RAN Alliance, such as an O-Cloud environment orchestrated by a Service Management and Orchestration Framework via an O-2 interface.

Applications 502 (which may alternatively be called software instances, virtual appliances, network functions, virtual nodes, virtual network functions, etc.) are run in the virtualization environment 400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

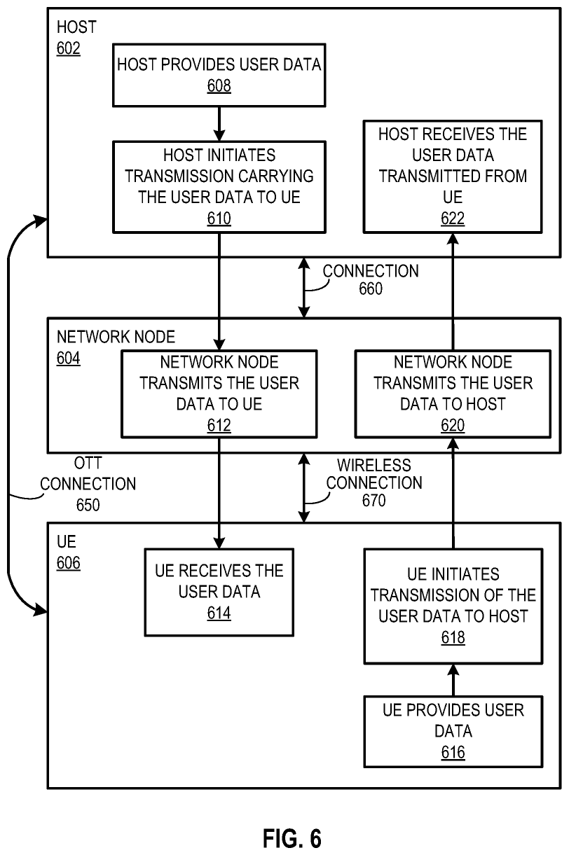

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1), network node (such as network node 110a of FIG. 1), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may reduce the power consumption and processing cost and thereby provide benefits such as extended battery lifetime and better responsiveness.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc. ; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

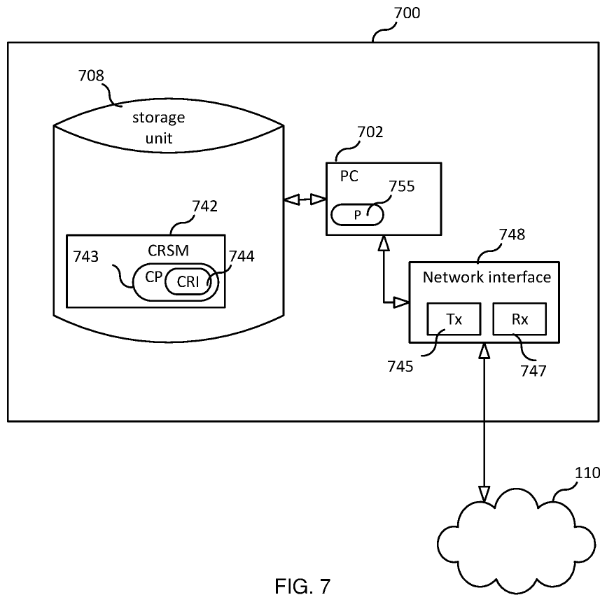

FIG. 7 is a block diagram of network node 700, according to some embodiments, which can be used to implement any core network node. As shown in FIG. 7, network node 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 700 may be a distributed computing apparatus); at least one network interface 748 (e.g., a physical interface or air interface) comprising a transmitter (Tx) 745 and a receiver (Rx) 747 for enabling network node 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling network node 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes network node 700 to perform steps described herein (e.g., steps described herein with reference to the flow charts). In other embodiments, network node 700 may be configured to perform steps described herein without the need for code.

That is, for example, PC 702 may consist merely of one or more ASICs. Hence, the features of the embodiments described herein may be implemented in hardware and/or software.

### SUMMARY OF VARIOUS EMBODIMENTS

A1. A method for network slice location restriction, the method comprising: transmitting to a UE (e.g., UE 112), a message comprising network slice information indicating a network slice (e.g., S-NSSAI, network slice group ID) and first location restriction information for the indicated network slice, wherein the first location restriction information for the network slice comprises a list of cell identifiers, IDs, wherein the list of cell IDs includes at least a first cell ID.
A2. The method of embodiment A1, further comprising: prior to transmitting the message to the UE, receiving a registration request message transmitted by the UE, wherein the message transmitted to the UE is a registration accept message that is responsive to the registration request message.
A3. The method of embodiment A2, further comprising: after receiving the registration request message, obtaining subscription information associated with the UE, wherein the subscription information comprises second location restriction information, and the second location restriction information comprises at least one of: one or more cell IDs that are included in the list of cell IDs, a geographical address, a postal code, a place name, a pair of coordinates (e.g., latitude and longitude).
A4. The method of embodiment A3, further comprising: generating the first location restriction information using the second location restriction information (e.g., converting a postal code or place name to a list of cell IDs).
A5. The method of embodiment A4, further comprising: prior to generating the first location restriction information and after receiving the registration request message, obtaining third location restriction information from a policy function, wherein the first location restriction information is generated using both the second location restriction information and the third location restriction information.
A6. The method of any one of embodiments A2-A5, wherein the method is performed by an Access and Mobility Management Function, AMF.
A7. The method of embodiment A6, wherein the registration accept message comprises a Service Area Restriction information element, IE, and the Service Area Restriction comprises the first location restriction information.
A8. The method of any one of embodiments A1-A7, wherein the first cell ID identifies a cell that supports the indicated network slice, or the first cell ID identifies a cell that does not support the indicated network slice.
A9. The method of any one of embodiments A1-A7, wherein the list of cell IDs comprises a plurality of cell IDs, and each said identified cell either i) supports the indicated network slice or ii) does not support the indicated network slice.
A10. The method of embodiment A9, wherein each cell ID included in the list of cell IDs identifies a cell that is within the same tracking area.
A11. The method of embodiment A1, wherein the message transmitted to the UE is a UE Configuration Update Command.
A12. The method of any one of embodiments A1-A11, further comprising: determining whether to transmit to a radio access network, RAN, node a message comprising the network slice information indicating the network slice and the first location restriction information for the indicated network slice.
A13. The method of any one of embodiments A1-A11, further comprising: prior to transmitting the message to the UE, obtaining capability information for the UE; and based on the obtained capability information, determining to include in the message the first location restriction information for the indicated network slice.
A14. The method of any one of embodiments A1-A13, wherein the network slice information indicating a network slice is a network slice group ID (e.g., NSAG) indicating a set of network slices and the first location restriction information applies to each network slice in the set of network slices.
AA1. A method (1100) performed by a user equipment, UE (112), or by a radio access network, RAN, node (110), the method comprising: receiving (s1102) a message comprising network slice information indicating a network slice and first location restriction information for the indicated network slice, wherein the first location restriction information comprises a list of cell identifiers, IDs, wherein the list of cell IDs includes at least a first cell ID.
AA2. The method of embodiment AA1, wherein the message is a UE Configuration Update Command.
AA3. The method of embodiment AA1, further comprising: prior to receiving the message comprising the NSI, transmitting a registration request message, wherein the message comprising the NSI is a registration accept message that is responsive to the registration request message.
AA4. The method of embodiment AA3, wherein the registration accept message comprises a Service Area Restriction information element, IE, and the Service Area Restriction IE comprises the first location restriction information.
AA5. The method of any one of embodiments AA1-AA4, further comprising: after receiving the message comprising the NSI, determining, based on the first location restriction information for the indicated network slice, whether to transmit a message related to the indicated network slice.
AA6. The method of embodiment AA5, wherein the UE is being served by a serving cell having a cell ID, and determining, based on the first location restriction information for the indicated network slice, whether to transmit the message related to the indicated network slice comprises determining whether the cell ID for the serving cell is included in the list of cell IDs.
AA7. The method of embodiment AA5 or AA6, wherein the message related to the indicated network slice is a registration request message for registering the indicated network slice, a PDU session establishment request comprising a network slice ID for the indicated network slice, or a service request comprising the network slice ID.
AA8. The method of any one of embodiments AA1-AA7, wherein the list of cell IDs comprises a plurality of cell IDs, each cell ID included in the list of cell IDs identifies a cell that is within the same tracking area, TA, and each cell ID included in the list identifies a cell that supports the indicated network slice or each cell ID included in the list identifies a cell that does not support the indicated network slice.
AA9. The method of any one of embodiments AA1-AA8, wherein the network slice information indicating a network slice is a network slice group ID indicating a set of network slices, and the first location restriction information applies to each network slice in the set of network slices.
AA9.1. The method of any one of embodiments AA1-AA8, wherein the network slice information indicates two or more network slices including said indicated network slice, and the first location restriction information applies to each network slice indicated by the network slice information (e.g., the NSI comprises a first S-NSSAI identifying a first network slice and a second S-NSSAI identifying a second network slice).
AA10. The method of any one of embodiment AA1-AA9.1, further comprising: enforcing the first location restriction information.
AB1. A method (1200) performed by a Unified Data Manager, UDM (804), the method comprising: transmitting (s1202) to an AMF (802) a message comprising network slice information indicating a network slice and first location restriction information for the indicated network slice, wherein the first location restriction information for the network slice comprises: a list of cell identifiers, IDs, and/or geographic information (e.g., zip code).
B1. A method (1300) for network slice location restriction, the method comprising: transmitting (s1302) to a UE (112) a first message comprising information indicating that a network slice group is subject to a cell based location restriction, wherein the network slice group includes a least a first network slice.
B2. The method of embodiment B1, further comprising: prior to transmitting the first message to the UE, receiving a registration request message transmitted by the UE, wherein the first message transmitted to the UE is a registration accept message that is responsive to the registration request message.
B3. The method of embodiment B1 or B2, further comprising: prior to transmitting the first message to the UE, receiving a second message comprising information indicating that the network slice group is subject to a cell based location restriction.
B4. The method of any one of embodiments B1-B3, wherein the information included in the first message comprises a network slice group identifier (e.g., a NSAG, network slice access stratum group, ID) that identifies the network slice group that is subject to the cell based location restriction.
B5. The method of any one of embodiments B1-B4, further comprising: prior to transmitting the message to the UE, obtaining capability information for the UE; and based on the obtained capability information, determining to include in the first message the information indicating that the network slice group is subject to a cell based location restriction.
B6. The method of any one of embodiments B1-B5, wherein the first message further comprises network slice information indicating a network slice (e.g., S-NSSAI) and first location restriction information for the indicated network slice, wherein the first location restriction information for the network slice comprises a list of cell identifiers, IDs.
C1. A method (1400) for network slice location restriction, the method comprising: a UE (112) receiving (s1402) from a core network function (e.g., AMF (802) a first message comprising information indicating that a network slice group is subject to a cell based location restriction.
C2. The method of embodiment C1, further comprising: the UE receiving system information broadcast by a base station serving a cell; the UE determining whether the cell served by the base station supports the group of network slices, wherein the determining comprises: the UE determining whether the system information includes a group ID that identifies the network slice group.
C3. The method of embodiment C2, wherein the first message comprises a group ID that identifies the network slice group, and determining whether the system information includes a group ID that identifies the network slice group comprises determining whether the system information includes a group ID that is identical to the group ID included in the first message.
C4. The method of embodiment C2 or C3, further comprising: after determining that the cell served by the base station supports the group of network slices, the UE transmitting a registration request to register with one of the network slices in the group.
C5. The method of embodiment C2 or C3, further comprising: after determining that the cell supports the group of network slices, the UE transmitting to the base station serving the cell a message comprising a network slice identifier identifying one of the network slices in the group.
C6. The method of embodiment C5, wherein the message further comprise a Protocol Data Unit (PDU) Session Establishment Request or a Service Request.
C7. A method (1500) performed by a radio access network, RAN, node (110), serving a cell, the method comprising: obtaining (s1502) information indicating that the cell supports a network slice group that is subject to a cell based location restriction; and transmitting (s1504) in the cell system information for the cell, wherein the system information comprises information indicating that the cell supports the network slice group.
C8. The method of claim C7, wherein the information indicating that the cell supports the network slice group comprise a network slice group identifier that identifies the network slice group.
D1. A method (1600) performed by a radio access network, RAN, node (110), the method comprising: transmitting (s1602) to a management function of a core network (e.g., AMF) a message comprising information indicating that a particular network slice group is subject to a cell based location restriction.
D2. The method of embodiment D1, wherein the message is RAN Configuration Update message, or the message is an NG Setup Request Message.
D3. The method of embodiment D1 or D2, wherein the message further comprises location restriction information indicating a set of cells that support the particular network slice group.
D4. The method of embodiment D3, wherein the location restriction information comprises a list of cell identifiers for indicating the set of cells that support the particular network slice group and/or geographic information for indicating said set of cells.

### ADDITIONAL DISCLOSURE

### Network Slice or Service Availability on a Per Cell Level Granularity

### 1. Discussion

UE policies with URSP allows the PCF to generate the Route Selection Validation Criteria in the URSP with a Location Criteria. The Location Criteria can already be specified on a per cell level granularity. It is assumed that URSP with cell level granular Location Criteria will be part of the evaluation of a key issue (KI) (i.e., KI number 3 (KI #3).

In case using URSP on a per cell level granularity (possibly with other enhancements done in Rel-18) is not enough as there is additionally a need to enforce the logic and also to impact e.g. mobility. There are other existing logic to control UE's access and mobility i.e. NSAG and Service Area Restrictions.

The NSAG added in Rel-17 allows for impacting the mobility procedures to consider required network slices. The Rel-17 NSAG assumed homogeneous support of NSAGs within a RA/TA, i.e. to support KI #3 the cells of a TA/RA would need to be possibly supporting different NSAGs.

Service Area Restrictions controls whether the UE can access the network in a certain area, on a per TA level granularity, for normal services. The Service Area Restrictions Allowed Area can be extended to allow a list of cells for a specific Network Slice as to address the KI #3.

### 2. Proposal

### Controlling UE Access to the Network Per Network Slice on a Per Cell Level Granularity

### Introduction

The “Network Slice Area of Service for services not mapping to existing TAs boundaries” of the Key Issue #3: Network Slice Area of Service for services not mapping to existing TAs boundaries and Temporary network slices is addressed.

### Functional Description

Two mechanisms are provided to select among for addressing the case when Network Slice Area of Service for services not mapping to existing TAs boundaries. The two mechanisms are summarized as follows:
(1) Extend Access and mobility related policy information such that Service Area Restrictions can be set per S-NSSAI on a per cell level granularity. UDM can set Service Area Restrictions per subscribed S-NSSAI and also indicate the geographical information (e.g. longitude/latitude, zip code, etc) or list of cells, NSAGs if known. As per current logic the PCF can adjust the Service Area Restrictions, and then AMF sends the Service Area Restrictions to the UE. The UE then applies the Service Area Restrictions possibly on a per network slice and cell granularity.
(2) Extend NSAG allowing the cells of a RA/TA to possibly support different NSAGs i.e. allow non-homogeneous support of NSAGs within a RA/TA. Each cell can in SIB indicate whether the current cell supports certain NSAGs. The UE and NG-RAN does not activate UP/DRB of S-NSSAIs associated to NSAGs that are not supported in current cell. The NG-RAN can indicate to AMF during NG SETUP (CONFIGURATION UPDATE) that some NSAGs are supported in some cells of a TA (or list of TAs), besides the existing possibility to list used NSAGs per TA. Alternatively, the AMF or NSSF can be configured that some NSAGs requires UE capability to handle non-homogeneous support of NSAGs within TA (e.g. extended location restriction).

The operator decides on the mechanism to use depending on the wanted behaviour. A network can support one or both mechanisms.

If an operator chooses to implement both mechanisms than both lists can be sent to the UE and the UE applies both lists simultaneously in order to determine if it can access a slice in a specific cell.

### Procedures

### General

During initial registration the UE indicates that the UE is supporting the extended functionality i.e. URSP, Service Area Restrictions and/or NSAG. The AMF applies current logic and if the UE requests or subscribes to S-NSSAIs that are applicable for the extended location restriction and the UE does not support the extended functionality, the network decides whether to provide the applicable S-NSSAI in Allowed NSSAI and Configured NSSAI to the UE. The decision can be implemented as operator policy in AMF, or decided by another NF e.g. UDM, NSSF or PCF in which case the UE support needs to be forwarded to the NF.

As illustrated in FIG. 16, the initial registration procedure is executed as in 23.502 clause 4.2.2.2.2 with the following differences:
0. For the NSAG option, the NG-RAN can indicate to AMF during NG SETUP (CONFIGURATION UPDATE) that some NSAGs are supported in some cells of a TA (or list of TAs), besides the existing possibility to list used NSAGs per TA. If NGAP is not used to inform the AMF, then AMF is configured by OAM the NSAGs that requires additional UE support.
1. The UE indicates the UE's capability to support the extended location restriction functionality in the Registration message e.g. in the UE 5GMM Core Network Capability.
2. No changes to steps 2 to 14a of 23.502 clause 4.2.2.2.2.
3. If UDM is to be able to decide whether to provide S-NSSAIs applicable for extended location restriction to the UE, then AMF indicates whether the UE and serving network supports the extended location restriction functionality.
4. For the NSAG option, there are no changes. For the Service Area Restrictions option, the UDM can provide Service Area Restrictions with per S-NSSAI restrictions. The location information can be as currently, geographical information (e.g. longitude/latitude, zip code, etc) or list of cells, or NSAGs if known. The UDM can adapt the content based on the knowledge whether the UE and serving network supports the extended location restrictions.
5. For the Service Area Restrictions option, the AMF provides the subscribed Service Area Restrictions to the PCF and the PCF can adapt the content.
6. No changes to steps 14c to 20 of 23.502 clause 4.2.2.2.2.
7. The AMF provides the extended location restrictions to the UE. For the NSAG option, the AMF is aware from step 0 that some NSAGs requires additional UE capability i.e. if the UE does not support NSAG extension the AMF does not provide those NSAGs to the UE. The AMF can additionally indicate that the per cell level restrictions are to be executed for those NSAGs. For the Service Area Restrictions option, the AMF provides the extended Service Area Restrictions to the UE.
8. The UE stores the extended location restrictions and enforces the information. For the NSAG option, the UE does not activate UP if the NSAG is not supported by the current cell, and can adapt the cell re-selection. For the extended Service Area Restrictions option, the UE applies the Allowed or Non-Allowed Area per S-NSSAI and the granularity per list of cells or NSAG.
9. The NG-RAN enforces the extended location restrictions for the NSAG and Service Area Restrictions options. The AMF enforces the extended location restrictions for the Service Area Restrictions option, and AMF can be extended to also enforce the restrictions for the NSAG option e.g. by allowing UP for applicable S-NSSAIs only when the UE is within the allowed area. The UE can additionally report that the extended location restrictions been stored. No additional changes to steps 21b to 25 of 23.502 clause 4.2.2.2.2.

As stated above an operator can choose to support both options and send to the UE NSAG as well as well as the extended Service Area Restrictions to the UE in a Registration Accept Message. The UE uses the information provided in both to determine its access to a slice in a specific cell. Another option is for the AMF to combine both lists and sends a single consolidated list to the UE.

### Mobility Procedures

For idle mode mobility, the NSAG option can be used to influence the cell re-selection such that the UE prefer cells supporting the NSAGs associated with the S-NSSAIs the UE wants including when not all cells of a TA support the same NSAGs (this should not have any protocol impacts as is assumed to be already supported by RRC). The Service Area Restrictions extensions does not impact the idle mode mobility procedures.

For connected mode mobility, the NSAG option can enable the NG-RAN to steer the UE to cells supporting the NSAGs associated with the S-NSSAIs that the UE is using (by Allowed NSSAI and S-NSSAIs of activated PDU Sessions). For the Service Area Restrictions extension option, the NG-RAN gets the extensions as part of the Mobility Restriction List (that is extended with per S-NSSAI and per cell restrictions) and the Mobility Restrictions for CM-CONNECTED state when in RRC-Connected state are executed by the radio access network and the core network such that UP for the associated S-NSSAIs are not allowed to be activated (as per current procedures).

### Impacts on Services, Entities and Interfaces

NG-RAN: Support extended location restrictions for the NSAG option and for the Service Area Restrictions option.
AMF: Support extended location restrictions
PCF: Support extension with a per cell level granularity per network slice for Service Area Restrictions options.
UE: Support extended location restrictions and indicate the UE's support for e.g. For Service Area Restrictions option, support Service Area Restrictions on a per S-NSSAI and cell level granularity; Support NSAG extension.

### Conclusion

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE), the method comprising:
receiving a message comprising network slice information (NSI) indicating a network slice and first location restriction information for the indicated network slice, wherein the first location restriction information comprises a list of cell identifiers (IDs), and the list of cell IDs includes at least a first cell ID.

2. The method of claim 1, wherein the message is a UE Configuration Update Command.

3. The method of claim 1, further comprising:
prior to receiving the message comprising the NSI, transmitting a registration request message, wherein
the message comprising the NSI is a registration accept message that is responsive to the registration request message.

4. The method of claim 3, wherein
the registration accept message comprises a Service Area Restriction information element, IE, and
the Service Area Restriction IE comprises the first location restriction information.

5. The method of claim 1, further comprising:
after receiving the message comprising the NSI, determining, based on the first location restriction information for the indicated network slice, whether to transmit a message related to the indicated network slice.

6. The method of claim 5, wherein
the UE is being served by a serving cell having a cell ID, and
determining, based on the first location restriction information for the indicated network slice, whether to transmit the message related to the indicated network slice comprises determining whether the cell ID for the serving cell is included in the list of cell IDs.

7. The method of claim 5, wherein the message related to the indicated network slice is a registration request message for registering the indicated network slice, a PDU session establishment request comprising a network slice ID for the indicated network slice, or a service request comprising the network slice ID.

8. The method of claim 1, wherein
the list of cell IDs comprises a plurality of cell IDs,
each cell ID included in the list of cell IDs identifies a cell that is within the same tracking area, TA, and
each cell ID included in the list identifies a cell that supports the indicated network slice or each cell ID included in the list identifies a cell that does not support the indicated network slice.

9. The method of claim 1, wherein
the network slice information indicates two or more network slices including said indicated network slice, and
the first location restriction information applies to each network slice indicated by the network slice information.

10. A method for network slice location restriction, the method comprising:
transmitting to a user equipment (UE) a message comprising network slice information indicating a network slice and first location restriction information for the indicated network slice, wherein
the first location restriction information for the network slice comprises a list of cell identifiers (IDs), and
the list of cell IDs includes at least a first cell ID.

11. The method of claim 10, wherein the method is performed by an Access and Mobility Management Function (AMF).

12. The method of claim 10, further comprising:
receiving a registration request message transmitted by the UE; and
after receiving the registration request message, obtaining subscription information associated with the UE, wherein
the subscription information comprises second location restriction information, and
the second location restriction information comprises:
one or more cell IDs that are included in the list of cell IDs,
a geographical address,
a postal code,
a place name, and/or
a pair of coordinates.

13. The method of claim 12, further comprising:
generating the first location restriction information using the second location restriction information.

14. The method of claim 13, further comprising:
prior to generating the first location restriction information and after receiving the registration request message, obtaining third location restriction information from a policy function, wherein
the first location restriction information is generated using both the second location restriction information and the third location restriction information.

15. The method of claim 10, further comprising:
prior to transmitting the message to the UE, obtaining capability information for the UE; and
based on the obtained capability information, determining to include in the message the first location restriction information for the indicated network slice.

16-34. (canceled)

35. A network node, the network node comprising:
a receiver;
a transmitter; and
processing circuitry, wherein the network node is configured to perform a method for network slice location restriction, wherein the method comprises:
transmitting to a user equipment (UE) a message comprising network slice information indicating a network slice and first location restriction information for the indicated network slice, wherein
the first location restriction information for the network slice comprises a list of cell identifiers (IDs), and
the list of cell IDs includes at least a first cell ID.

36-37. (canceled)

38. A user equipment (UE), the UE comprising:
a transmitter; and
a receiver for receiving a message comprising network slice information indicating a network slice and first location restriction information for the indicated network slice, wherein
the first location restriction information comprises a list of cell identifiers (IDs), and
the list of cell IDs includes at least a first cell ID.

39-40. (canceled)

41. The UE of claim 38, wherein the UE is configured to:
prior to receiving the message comprising the NSI, employ the transmitter to transmit a registration request message, wherein
the message comprising the NSI is a registration accept message that is responsive to the registration request message.

42. The UE of claim 41, wherein
the registration accept message comprises a Service Area Restriction information element, IE, and
the Service Area Restriction IE comprises the first location restriction information.
